(19) United States
(12) Patent Application Publication
(10) Pub. No.: US 2024/0237702 A1
(43) Pub. Date: Jul. 18, 2024

(54) AEROSOL-GENERATING ARTICLE COMPRISING A SUSCEPTOR ELEMENT AND A WRAPPER WITH A METAL LAYER

(71) Applicant: Philip Morris Products S.A., Neuchatel (CH)

(72) Inventor: Farhang MOHSENI, Neuchatel (CH)

(73) Assignee: Philip Morris Products S.A., Neuchatel (CH)

(21) Appl. No.: 18/580,037

(22) PCT Filed: Jul. 20, 2022
(86) PCT No.: PCT/EP2022/070426

§ 371 Date: Jan. 17, 2024

(30) Foreign Application Priority Data
Jul. 20, 2021 (EP) 21186803.9

(51) Int. Cl. A24D 1/02; A24D 1/20; A24F 40/20; A24F 40/465; H05B 6/10

(52) U.S. Cl. CPC A24D 1/02; A24D 1/20; A24F 40/20; A24F 40/465; H05B 6/105

(57) ABSTRACT

An aerosol-generating article is provided, including: a rod of aerosol-forming substrate, the rod including a susceptor element within the aerosol-forming substrate; and a wrapper wrapped around the rod of aerosol-forming substrate, the wrapper including a metal layer, and the metal layer having a thickness of less than 100 nanometres. An aerosol-generating system including the aerosol-generating article and an aerosol-generating device is also provided.

The present invention relates to an aerosol-generating article comprising a susceptor element and a wrapper with a metal layer.

Aerosol-generating systems for delivering an aerosol to a user typically comprise an aerosol-generating article and an atomiser. The aerosol-generating article includes a rod of aerosol-forming substrate. The atomiser is configured to generate an inhalable aerosol from the aerosol-forming substrate. Some known aerosol-generating systems comprise a thermal atomiser such as an electric heater or an inductive heating device. The thermal atomiser is configured to heat and vaporise the aerosol-forming substrate to generate an aerosol, which can be inhaled by a user. Typical aerosol-forming substrates for use in aerosol-generating systems are nicotine formulations, which may include an aerosol former such as glycerine.

It would be desirable to provide an aerosol-generating article that includes a susceptor element and provides improved nicotine delivery.

There is provided an aerosol-generating article. The aerosol-generating article may comprise a rod of aerosol-forming substrate. The rod may comprise a susceptor element. The susceptor element may be provided within the aerosol-forming substrate. The aerosol-generating article may comprise a wrapper. The wrapper may be wrapped around the rod of aerosol-forming substrate. The wrapper may comprise a metal layer. The metal layer may have a thickness of less than or equal to 100 nanometres.

There is also provided an aerosol-generating article comprising: a rod of aerosol-forming substrate, the rod comprising a susceptor element within the aerosol-forming substrate; and a wrapper wrapped around the rod of aerosol-forming substrate, wherein the wrapper comprises a metal layer, and wherein the metal layer has a thickness of less than or equal to 100 nanometres.

There is also provided an aerosol-generating system. The aerosol-generating system may comprise an aerosol-generating article. The aerosol-generating article may comprise a rod of aerosol-forming substrate. The rod may comprise a susceptor element. The susceptor element may be provided within the aerosol-forming substrate. The aerosol-generating article may comprise a wrapper. The wrapper may be wrapped around the rod of aerosol-forming substrate. The wrapper may comprise a metal layer. The metal layer may have a thickness of less than or equal to 100 nanometres. The aerosol-generating system may comprise an aerosol-generating device. The aerosol-generating device may comprise an atomiser. The aerosol-generating device may comprise a power supply. The aerosol-generating device may comprise a controller. The controller may be programmed to control the power supplied from the power supply to the atomiser.

There is also provided an aerosol-generating system comprising an aerosol-generating article and an aerosol-generating device, the aerosol-generating article comprising: a rod of aerosol-forming substrate, the rod comprising a susceptor element within the aerosol-forming substrate; and a wrapper wrapped around the rod of aerosol-forming substrate, wherein the wrapper comprises a metal layer, and wherein the metal layer has a thickness of less than or equal to 100 nanometres, the aerosol-generating device comprising: an atomiser; a power supply; and a controller, the controller being programmed to control the power supplied from the power supply to the atomiser.

The provision of a wrapper wrapped around the rod of aerosol-forming substrate, and including a thin metal layer, may provide better nicotine delivery from the aerosol-forming substrate to a user.

In addition, the thinness of the metal layer may result in less interaction between the metal layer and the magnetic field that is generated to heat the susceptor element, which may allow for more consistent and more efficient heating of the susceptor element, while also providing the above mentioned better nicotine delivery.

The inventors believe that the metal layer may form a barrier between a surface or surfaces of the rod of aerosol-forming substrate and the other components of the aerosol-generating article. This barrier may reduce migration of one or more components of the aerosol-forming substrate, such as the aerosol former, out of the aerosol-forming substrate and into the other components of the aerosol-generating article.

An increase in the amount of nicotine delivered from the aerosol-forming substrate may be caused by the barrier reducing the migration of one or more components of the aerosol-forming substrate out of the aerosol-forming substrate.

Furthermore, use of a thin metal layer may reduce the amount of metal needed to form the metal layer, which may improve sustainability and may reduce waste.

As used herein, the term “aerosol-generating article” refers to an article for producing an aerosol. An aerosol-generating article typically comprises an aerosol-forming substrate that is suitable and intended to be heated or combusted in order to release volatile compounds that can form an aerosol. A conventional cigarette is lit when a user applies a flame to one end of the cigarette and draws air through the other end. The localised heat provided by the flame and the oxygen in the air drawn through the cigarette causes the end of the cigarette to ignite, and the resulting combustion generates an inhalable smoke. By contrast, in heated “aerosol-generating articles”, an aerosol is generated by heating an aerosol-forming substrate and not by combusting the aerosol-forming substrate. Known heated aerosol-generating articles include, for example, electrically heated aerosol-generating articles.

As used herein, the term “aerosol-forming substrate” refers to a substrate that is capable of producing upon heating volatile compounds, which can form an aerosol. The aerosol generated from aerosol-forming substrate may be visible to the human eye or invisible and may include vapours (for example, fine particles of substances, which are in a gaseous state, that are ordinarily liquid or solid at room temperature) as well as gases and liquid droplets of condensed vapours.

As used herein with reference to the present invention, the term “susceptor element” refers to a material that can convert electromagnetic energy into heat. When located within a fluctuating electromagnetic field, eddy currents induced in the susceptor element cause heating of the susceptor element. As the susceptor element is located in thermal contact with the aerosol-forming substrate, the aerosol-forming substrate is heated by the susceptor element.

The metal layer may comprise one or more of the following metals: aluminium, chromium, copper, gold, nickel, silver, and tin. The metal layer may be formed from aluminium. The metal layer may comprise an aluminium layer. Advantageously, aluminium has a relatively low boiling point, which may make it easier to form the metal layer, particularly when using vapour deposition. In addition, aluminium has a lower cost when compared to other metals.

If the metal layer is too thin then it may not be possible to manufacture the metal layer, and the metal layer may have less anti-capillary properties. However, if the metal layer is too thick then there may be more interaction with a magnetic field when the aerosol-generating article is inductively heated, and the metal layer may be more expensive to manufacture.

The metal layer may have a thickness of less than 5000 nanometres. The metal layer may have a thickness of less than 4000 nanometres. The metal layer may have a thickness of less than 3000 nanometres. The metal layer may have a thickness of less than 2000 nanometres. The metal layer may have a thickness of less than 1000 nanometres. The metal layer may have a thickness of less than 500 nanometres. The metal layer may have a thickness of less than 400 nanometres. The metal layer may have a thickness of less than 300 nanometres. The metal layer may have a thickness of less than 250 nanometres. The metal layer may have a thickness of less than 200 nanometres. The metal layer may have a thickness of less than 150 nanometres. The metal layer may have a thickness of less than 100 nanometres. The metal layer may have a thickness of less than 90 nanometres. The metal layer may have a thickness of less than 80 nanometres. The metal layer may have a thickness of less than 70 nanometres. The metal layer may have a thickness of less than 60 nanometres. The metal layer may have a thickness of less than 50 nanometres. The metal layer may have a thickness of less than 45 nanometres. The metal layer may have a thickness of less than 40 nanometres. The metal layer may have a thickness of less than 35 nanometres. The metal layer may have a thickness of less than 30 nanometres. The metal layer may have a thickness of less than 25 nanometres. The metal layer may have a thickness of less than 20 nanometres.

The metal layer may have a thickness of greater than or equal to 1 nanometres. The metal layer may have a thickness of greater than or equal to 10 nanometres. The metal layer may have a thickness of greater than or equal to 15 nanometres. The metal layer may have a thickness of greater than or equal to 20 nanometres. The metal layer may have a thickness of greater than or equal to 25 nanometres. The metal layer may have a thickness of greater than or equal to 30 nanometres. The metal layer may have a thickness of greater than or equal to 35 nanometres. The metal layer may have a thickness of greater than or equal to 40 nanometres. The metal layer may have a thickness of greater than or equal to 45 nanometres. The metal layer may have a thickness of greater than or equal to 50 nanometres. The metal layer may have a thickness of greater than or equal to 60 nanometres. The metal layer may have a thickness of greater than or equal to 70 nanometres. The metal layer may have a thickness of greater than or equal to 80 nanometres. The metal layer may have a thickness of greater than or equal to 90 nanometres. The metal layer may have a thickness of greater than or equal to 100 nanometres. The metal layer may have a thickness of greater than or equal to 150 nanometres. The metal layer may have a thickness of greater than or equal to 200 nanometres. The metal layer may have a thickness of greater than or equal to 250 nanometres. The metal layer may have a thickness of greater than or equal to 300 nanometres. The metal layer may have a thickness of greater than or equal to 350 nanometres. The metal layer may have a thickness of greater than or equal to 400 nanometres. The metal layer may have a thickness of greater than or equal to 450 nanometres. The metal layer may have a thickness of greater than or equal to 500 nanometres. The metal layer may have a thickness of greater than or equal to 1000 nanometres. The metal layer may have a thickness of greater than or equal to 2000 nanometres. The metal layer may have a thickness of greater than or equal to 3000 nanometres. The metal layer may have a thickness of greater than or equal to 4000 nanometres.

The metal layer may have a thickness of between 1 nanometre and 1000 nanometres. The metal layer may have a thickness of between 1 nanometre and 900 nanometres. The metal layer may have a thickness of between 1 nanometre and 800 nanometres. The metal layer may have a thickness of between 1 nanometre and 700 nanometres. The metal layer may have a thickness of between 1 nanometre and 600 nanometres. The metal layer may have a thickness of between 1 nanometre and 500 nanometres. The metal layer may have a thickness of between 1 nanometre and 400 nanometres. The metal layer may have a thickness of between 1 nanometre and 300 nanometres. The metal layer may have a thickness of between 1 nanometre and 200 nanometres. The metal layer may have a thickness of between 1 nanometre and 100 nanometres. The metal layer may have a thickness of between 1 nanometre and 90 nanometres. The metal layer may have a thickness of between 1 nanometre and 80 nanometres. The metal layer may have a thickness of between 1 nanometre and 70 nanometres. The metal layer may have a thickness of between 1 nanometre and 60 nanometres. The metal layer may have a thickness of between 1 nanometre and 50 nanometres. The metal layer may have a thickness of between 1 nanometre and 40 nanometres. The metal layer may have a thickness of between 1 nanometre and 30 nanometres. The metal layer may have a thickness of between 1 nanometre and 20 nanometres.

The metal layer may have a thickness of between 10 nanometres and 200 nanometres. The metal layer may have a thickness of between 10 nanometres and 150 nanometres. The metal layer may have a thickness of between 10 nanometres and 100 nanometres. The metal layer may have a thickness of between 10 nanometres and 90 nanometres. The metal layer may have a thickness of between 15 nanometres and 90 nanometres. The metal layer may have a thickness of between 15 nanometres and 80 nanometres. The metal layer may have a thickness of between 20 nanometres and 80 nanometres. The metal layer may have a thickness of between 20 nanometres and 70 nanometres. The metal layer may have a thickness of between 25 nanometres and 70 nanometres. The metal layer may have a thickness of between 25 nanometres and 60 nanometres. The metal layer may have a thickness of between 30 nanometres and 60 nanometres. The metal layer may have a thickness of between 30 nanometres and 50 nanometres. The metal layer may have a thickness of between 30 nanometres and 45 nanometres. The metal layer may have a thickness of between 30 nanometres and 40 nanometres.

The metal layer may be wrapped around at least 50 percent of the length of the rod of aerosol-forming substrate. The metal layer may be wrapped around at least 60 percent of the length of the rod of aerosol-forming substrate. The metal layer may be wrapped around at least 70 percent of the length of the rod of aerosol-forming substrate. The metal layer may be wrapped around at least 80 percent of the length of the rod of aerosol-forming substrate. The metal layer may be wrapped around at least 90 percent of the length of the rod of aerosol-forming substrate.

The metal layer may be wrapped around the entire length of the rod of aerosol-forming substrate.

The wrapper may be wrapped around at least 50 percent of the length of the rod of aerosol-forming substrate. The wrapper may be wrapped around at least 60 percent of the length of the rod of aerosol-forming substrate. The wrapper may be wrapped around at least 70 percent of the length of the rod of aerosol-forming substrate. The wrapper may be wrapped around at least 80 percent of the length of the rod of aerosol-forming substrate. The wrapper may be wrapped around at least 90 percent of the length of the rod of aerosol-forming substrate.

The wrapper may be wrapped around the entire length of the rod of aerosol-forming substrate.

The wrapper may comprise a paper layer.

As used herein, the term “paper layer” is used to describe a layer formed from cellulosic fibres.

The paper layer may be a non-metallic layer. In other words, the paper layer is not a metal layer or an alloy layer.

The metal layer may be radially inward of the paper layer.

Alternatively, the metal layer may be radially outward of the paper layer.

The wrapper may comprise a metal layer deposited on the paper layer. The metal layer may be formed by physical vapour deposition. Advantageously, depositing the metal layer on the paper layer may allow for the wrapper to be very thin.

If the paper layer is too thin then the paper layer may not provide enough resistance to tearing. If the paper layer is too thick then the wrapper may be too difficult to roll during manufacture, which may reduce the speed of manufacture of the aerosol-generating article.

The paper layer may have a thickness of greater than or equal to 10 micrometres. The paper layer may have a thickness of greater than or equal to 20 micrometres. The paper layer may have a thickness of greater than or equal to 40 micrometres.

The paper layer may have a thickness of less than 120 micrometres. The paper layer may have a thickness of less than 100 micrometres. The paper layer may have a thickness of less than 80 micrometres.

The paper layer may have a thickness of between 10 micrometres and 120 micrometres. The paper layer may have a thickness of between 10 micrometres and 100 micrometres. The paper layer may have a thickness of between 10 micrometres and 80 micrometres.

The paper layer may have a thickness of between 20 micrometres and 120 micrometres. The paper layer may have a thickness of between 20 micrometres and about 100 micrometres. The paper layer may have a thickness of between 20 micrometres and 80 micrometres.

The paper layer may have a thickness of between 40 micrometres and 120 micrometres. The paper layer may have a thickness of between 40 micrometres and 100 micrometres. The paper layer may have a thickness of between 40 micrometres and 80 micrometres.

The aerosol-generating article may comprise a plurality of susceptor elements.

The susceptor element may be embedded within the rod of aerosol-forming substrate.

The susceptor element may be an elongate susceptor element. The susceptor element may be rod-shaped. The susceptor element may be flat. Preferably, the susceptor element has a length of 12 mm. Preferably, the susceptor element has a width of 5 mm. Preferably, the susceptor element has a thickness of 60 μm.

When used for describing the susceptor element, the term “elongate” means that the susceptor element has a length dimension that is greater than its width dimension or its thickness dimension. For example, the length dimension may be greater than twice the width dimension or the thickness dimension.

The susceptor element may be arranged substantially longitudinally within the aerosol-generating article. This means that the length dimension of the susceptor element is arranged to be approximately parallel to the longitudinal direction of the aerosol-generating article. For example, the susceptor element may be arranged to be within plus or minus 10 degrees of parallel to the longitudinal direction of the aerosol-generating article. The susceptor element may be positioned in a radially central position within the aerosol-generating article. The susceptor element may extend along the longitudinal axis of the rod.

The susceptor element may extend the entire length of the rod of aerosol-forming substrate.

The susceptor element may be a plurality of susceptor particles which may be deposited on or embedded within the rod of aerosol-forming substrate. The susceptor particles may be immobilized by the rod of aerosol-forming substrate and remain at an initial position. The susceptor particles may be homogeneously distributed in the rod of aerosol- forming substrate. Due to the particulate nature of the susceptor, heat may be produced according to the distribution of the particles in the rod of aerosol-forming substrate. Alternatively, the susceptor element may be in the form of one or more sheets, strips, shreds or rods that may be placed next to or embedded in the rod of aerosol-forming substrate. The aerosol-forming substrate may comprise one or more susceptor strips.

As used herein, the term “thickness” refers to the distance through the susceptor, from one external face to another external face. The susceptor element may have a thickness of between 1 millimetre and 5 millimetres. The susceptor element may have a thickness of between 0.01 millimetres and 2 millimetres. The susceptor element may have a thickness of between 0.5 millimetres and 2 millimetres. The susceptor element may have a thickness of between 10 micrometres and 500 micrometres. The susceptor element may have a thickness of between 10 micrometres and 100 micrometres.

The susceptor may have a constant cross- section. The susceptor element may have a circular cross-section. If the susceptor element has a circular cross-section, the susceptor element may have a diameter of between 1 millimetre and 5 millimetres. The diameter of a susceptor with a non-circular cross-section, such as a flat susceptor, may be equivalent to the thickness of the flat susceptor.

The susceptor element may have a diameter of less than 5 millimetres. The susceptor element may have a diameter of less than 4 millimetres. The susceptor element may have a diameter of less than 3 millimetres. The susceptor element may have a diameter of less than 2 millimetres.

The susceptor element may have a diameter of greater than or equal to 1 millimetre. The susceptor element may have a diameter of greater than or equal to 2 millimetres. The susceptor element may have a diameter of greater than or equal to 3 millimetres The susceptor element may have a diameter of greater than or equal to 4 millimetres.

For example, when the susceptor element has a circular cross-section, the width of the susceptor element may be the same as the diameter of the susceptor element.

A ratio of the thickness of the susceptor element to the thickness of the metal layer may be less than 3000. A ratio of the thickness of the susceptor element to the thickness of the metal layer may be less than 2750. A ratio of the thickness of the susceptor element to the thickness of the metal layer may be less than 2500. A ratio of the thickness of the susceptor element to the thickness of the metal layer may be less than 2250. A ratio of the thickness of the susceptor element to the thickness of the metal layer may be less than 2000. A ratio of the thickness of the susceptor element to the thickness of the metal layer may be less than 1750. A ratio of the thickness of the susceptor element to the thickness of the metal layer may be less than 1500. A ratio of the thickness of the susceptor element to the thickness of the metal layer may be less than 1250. A ratio of the thickness of the susceptor element to the thickness of the metal layer may be less than 1000.

A ratio of the thickness of the susceptor element to the thickness of the metal layer may be greater than or equal to 1000. A ratio of the thickness of the susceptor element to the thickness of the metal layer may be greater than or equal to 1250. A ratio of the thickness of the susceptor element to the thickness of the metal layer may be greater than or equal to 1500. A ratio of the thickness of the susceptor element to the thickness of the metal layer may be greater than or equal to 1750. A ratio of the thickness of the susceptor element to the thickness of the metal layer may be greater than or equal to 2000. A ratio of the thickness of the susceptor element to the thickness of the metal layer may be greater than or equal to 2250. A ratio of the thickness of the susceptor element to the thickness of the metal layer may be greater than or equal to 2500. A ratio of the thickness of the susceptor element to the thickness of the metal layer may be greater than or equal to 2750. A ratio of the thickness of the susceptor element to the thickness of the metal layer may be greater than or equal to 3000.A ratio of the thickness of the susceptor element to the thickness of the metal layer may be between 1000 and 3000. A ratio of the thickness of the susceptor element to the thickness of the metal layer may be between 1250 and 3000. A ratio of the thickness of the susceptor element to the thickness of the metal layer may be between 1250 and 2750. A ratio of the thickness of the susceptor element to the thickness of the metal layer may be between 1500 and 2750. A ratio of the thickness of the susceptor element to the thickness of the metal layer may be between 1500 and 2500. A ratio of the thickness of the susceptor element to the thickness of the metal layer may be between 1750 and 2500. A ratio of the thickness of the susceptor element to the thickness of the metal layer may be between 1750 and 2250. A ratio of the thickness of the susceptor element to the thickness of the metal layer may be between 2000 and 2250. A ratio of the thickness of the susceptor element to the thickness of the metal layer may be between 1750 and 2000.

The aerosol-generating article may comprise an outermost wrapper wrapped around at least the rod of aerosol-forming substrate and the wrapper.

The outermost wrapper may be formed from paper.

The aerosol-generating article may comprise an upstream element located upstream of the aerosol-forming substrate. The upstream element may be located adjacent to the aerosol-forming substrate.

Advantageously, provision of an upstream element in combination with the metal layer of the wrapper may result in reduced migration of one or more components of the aerosol-forming substrate to other parts of the aerosol-generating article.

The upstream element may comprise a porous element. The porous element may not significantly alter the resistance to draw of the aerosol-generating article.

The upstream element may comprise an annular element.

The wrapper may be wrapped around at least a portion of the upstream element. The wrapper may be wrapped around at least 5 percent of the length of the upstream element. The wrapper may be wrapped around at least 10 percent of the length of the upstream element. The wrapper may be wrapped around at least 20 percent of the length of the upstream element. The wrapper may be wrapped around at least 30 percent of the length of the upstream element. The wrapper may be wrapped around at least 40 percent of the length of the upstream element. The wrapper may be wrapped around at least 50 percent of the length of the upstream element. The wrapper may be wrapped around the entire length of the upstream element.

Advantageously, providing the wrapper over at least a portion of the upstream element may reduce migration of components of the aerosol-forming substrate through the join between the aerosol-forming substrate and the upstream element.

The upstream element may be made of any material suitable for use in an aerosol-generating article. The upstream element may be made of a same material as used for one of the other components of the aerosol-generating article. Suitable materials for forming the upstream element include filter materials, ceramic, polymer material, cellulose acetate, cardboard, zeolite or aerosol-generating substrate. The upstream element may be formed from a plug of cellulose acetate.

The upstream element may be formed of a heat resistant material. For example, the upstream element may be formed of a material that resists temperatures of up to 350 degrees Celsius. This may ensure that the upstream element is not adversely affected by the heating means for heating the aerosol-generating substrate.

The upstream element may have a diameter that is approximately equal to the diameter of the aerosol-generating article.

The upstream element may have a length of between 1 millimetre and 10 millimetres. The upstream element may have a length of between 3 millimetres and 8 millimetres. The upstream element may have a length of between 4 millimetres and 6 millimetres.

The upstream element may have a length of 5 millimetres.

The length of the upstream element can advantageously be varied in order to provide the desired total length of the aerosol-generating article. For example, where it is desired to reduce the length of one of the other components of the aerosol-generating article, the length of the upstream element may be increased in order to maintain the same overall length of the article.

The aerosol-generating article may comprise a downstream element located downstream of the aerosol-forming substrate. The downstream element may be located adjacent to the aerosol-forming substrate.

Advantageously, provision of an downstream element in combination with the metal layer of the wrapper may result in reduced migration of one or more components of the aerosol-forming substrate to other parts of the aerosol-generating article.

The wrapper may be wrapped around at least a portion of the downstream element. The wrapper may be wrapped around at least 5 percent of the length of the downstream element. The wrapper may be wrapped around at least 10 percent of the length of the downstream element. The wrapper may be wrapped around at least 20 percent of the length of the downstream element. The wrapper may be wrapped around at least 30 percent of the length of the downstream element. The wrapper may be wrapped around at least 40 percent of the length of the downstream element. The wrapper may be wrapped around at least 50 percent of the length of the downstream element. The wrapper may be wrapped around the entire length of the downstream element.

Advantageously, providing the wrapper over at least a portion of the downstream element may reduce migration of components of the aerosol-forming substrate through the join between the aerosol-forming substrate and the downstream element.

The downstream element may be made of any material suitable for use in an aerosol-generating article. The downstream element may be made of a same material as used for one of the other components of the aerosol-generating article. Suitable materials for forming the downstream element include filter materials, ceramic, polymer material, cellulose acetate, cardboard, zeolite or aerosol-generating substrate. The downstream element may be formed from a plug of cellulose acetate.

The downstream element may be formed of a heat resistant material. For example, the upstream element may be formed of a material that resists temperatures of up to 350 degrees Celsius. This may ensure that the downstream element is not adversely affected by the heating means for heating the aerosol-generating substrate.

The downstream element may comprise a hollow tubular segment. The hollow tubular segment may also be located adjacent to the aerosol-forming substrate.

The hollow tubular segment may comprise a cellulose acetate tube. The hollow tubular segment may comprise two cellulose acetate tubes.

Advantageously, providing the wrapper over at least a portion of the hollow tubular segment may reduce migration of components of the aerosol-forming substrate through the join between the aerosol-forming substrate and the hollow tubular segment.

The downstream element may comprise a hollow tubular segment.

The downstream element may comprise a filter plug element.

The downstream element may comprise a mouthpiece element at its downstream end. The mouthpiece element may comprise a mouth end cavity. The mouth end cavity may be defined by a hollow tubular element provided at the downstream end of the mouthpiece element. Alternatively, the mouth end cavity may be defined by the outer wrapper, wherein the outer wrapper extends in a downstream direction from the mouthpiece element.

The aerosol-forming substrate may comprise a gel. The aerosol-forming substrate may comprise a film. The aerosol-forming substrate may comprise crimped tobacco. The aerosol-forming substrate may comprise cut tobacco filler.

The aerosol-forming substrate may comprise a colloid. The colloid may have discontinuous solid particles dispersed in a continuous liquid. The colloid may have discontinuous liquid particles dispersed in a continuous liquid. The colloid may have discontinuous liquid particles dispersed in a continuous solid.

As used herein, unless indicated otherwise, the term “percent by weight” refers to dry weight.

The aerosol-forming substrate may have an aerosol former content of greater than or equal to 5 percent by weight. The aerosol-forming substrate may have an aerosol former content of greater than or equal to 10 percent by weight. The aerosol-forming substrate may have an aerosol former content of greater than or equal to 15 percent by weight. The aerosol-forming substrate may have an aerosol former content of greater than or equal to 20 percent by weight. The aerosol-forming substrate may have an aerosol former content of greater than or equal to 25 percent by weight. The aerosol-forming substrate may have an aerosol former content of greater than or equal to 30 percent by weight. The aerosol-forming substrate may have an aerosol former content of greater than or equal to 35 percent by weight. The aerosol-forming substrate may have an aerosol former content of greater than or equal to 40 percent by weight. The aerosol-forming substrate may have an aerosol former content of greater than or equal to 45 percent by weight. The aerosol-forming substrate may have an aerosol former content of greater than or equal to 50 percent by weight. The aerosol-forming substrate may have an aerosol former content of greater than or equal to 60 percent by weight. The aerosol-forming substrate may have an aerosol former content of greater than or equal to 70 percent by weight. The aerosol-forming substrate may have an aerosol former content of greater than or equal to 80 percent by weight. The aerosol-forming substrate may have an aerosol former content of greater than or equal to 90 percent by weight. The aerosol-forming substrate may have an aerosol former content of greater than or equal to 95 percent by weight.

The aerosol-forming substrate may have an aerosol former content of less than 95 percent by weight. The aerosol-forming substrate may have an aerosol former content of less than 90 percent by weight. The aerosol-forming substrate may have an aerosol former content of less than 80 percent by weight. The aerosol-forming substrate may have an aerosol former content of less than 70 percent by weight. The aerosol-forming substrate may have an aerosol former content of less than 60 percent by weight. The aerosol-forming substrate may have an aerosol former content of less than 50 percent by weight. The aerosol-forming substrate may have an aerosol former content of less than 40 percent by weight.

The aerosol-generating system may include an aerosol-generating device.

The aerosol-generating device may comprise a housing defining a device cavity configured to receive at least a portion of the aerosol-generating article.

The aerosol-generating device may comprise an atomiser configured to generate an aerosol from the aerosol-forming substrate.

The atomiser may be a thermal atomiser.

As used herein, the term “thermal atomiser” describes an atomiser that is configured to heat the aerosol-forming substrate to generate an aerosol.

The aerosol-generating device may comprise any suitable type of thermal atomiser. For example, the thermal atomiser may comprise a heater. The thermal atomiser may comprise an electric heater. In one example, the thermal atomiser may comprise an electric heater comprising a heating element. The heating element may be a resistive heating element.

In one example, the heating element may comprise a heater blade or pin adapted to be inserted into the aerosol-forming substrate so that the aerosol-forming substrate is heated from its inside. In another example, the heating element may partially or completely surround the aerosol-forming substrate and heat the aerosol-forming substrate circumferentially from its outside.

In another example, the thermal atomiser may comprise an inductive heating device. Inductive heating devices typically comprise an induction source that is configured to be coupled to a susceptor element, which may be provided externally to the aerosol-forming substrate or internally within the aerosol-forming substrate. The induction source generates an alternating electromagnetic field that induces magnetization or eddy currents in the susceptor element. The susceptor element may be heated as a result of hysteresis losses or induced eddy currents which heat the susceptor element through ohmic or resistive heating.

The aerosol-generating device may include a susceptor. The susceptor element may be as described above in relation to the aerosol-generating article.

An aerosol-generating device comprising an inductive heating device may be configured to receive an aerosol-generating article having the aerosol-forming substrate and a susceptor element in thermal proximity to the aerosol-forming substrate. Typically, the susceptor element is in direct contact with the aerosol-forming substrate and heat is transferred from the susceptor element to the aerosol-forming substrate primarily by conduction.

Examples of electrically operated aerosol-generating systems having inductive heating devices and aerosol-generating articles having susceptor elements are described in WO-A1-95/27411 and WO-A1-2015/177255.

The aerosol-generating device may comprise a power supply. The power supply may be a DC power supply. The power supply may comprise a battery.

The aerosol-generating device may comprise a controller. The controller may be a microcontroller. The controller may be programmed to control the power supplied from the power supply to the atomiser.

When the thermal atomiser is an inductive heating device, the controller may be programmed to control the duration of each pulse of power supplied by the power supply to the inductive heating device. The controller may be programmed to control the duration of the time interval between successive pulses of power supplied by the power supply to the inductive heating device. The controller may be programmed to determine an apparent resistance (Rₐ) of a susceptor element of an aerosol-generating article engaged with the inductive heating device. The controller may be programmed to determine an apparent resistance (Rₐ) of the susceptor element from measurements of at least one of the voltage (V_{Dc}) supplied from the power supply and the current (I_{DC}) drawn from the power supply. The controller may be further programmed to determine the temperature of the susceptor element of the aerosol-generating article from the apparent resistance (Rₐ). The controller may be programmed to determine the temperature of the aerosol-forming substrate of the aerosol-generating article from the temperature of the susceptor element.

When the aerosol-generating device include a controller that controls the power supplied to the atomiser, wrappers that have thick metal layers may interact with the control provided by the controller, which could result in inefficient heating of the susceptor element. Advantageously, the thinness of the metal layer of the wrapper may reduce interference between the metal layer and the controller, which may result in more consistent heating of the susceptor element.

It will be appreciated that any features described herein in relation to one embodiment of an aerosol-forming substrate, an aerosol-generating article, an aerosol-generating device, or an aerosol-generating system may also be applicable to other embodiments of aerosol-forming substrates, an aerosol-generating articles, an aerosol-generating devices, or aerosol-generating systems according to this disclosure. A feature described in relation to one embodiment may be equally applicable to another embodiment in accordance with this disclosure. It will also be appreciated that an aerosol generator according to this disclosure may be provided in an aerosol-generating device without a cartridge. Accordingly, any of the features described herein with relation to a cartridge may be equally applicable to an aerosol-generating device.

The invention is defined in the claims. However, below there is provided a non-exhaustive list of non-limiting examples. Any one or more of the features of these examples may be combined with any one or more features of another example, embodiment, or aspect described herein.

EX1. An aerosol-generating article comprising:
a rod of aerosol-forming substrate, the rod comprising a susceptor element within the aerosol-forming substrate; and
a wrapper wrapped around the rod of aerosol-forming substrate,
wherein the wrapper comprises a metal layer, and
wherein the metal layer has a thickness of less than 100 nanometres.

EX2. An aerosol-generating article according to example EX1, wherein the metal layer has a thickness of less than 80 nanometres.

EX3. An aerosol-generating article according to example EX1 or example EX2, wherein the metal layer has a thickness of less than 60 nanometres.

EX4. An aerosol-generating article according to any one of examples EX1 to EX3, wherein the metal layer has a thickness of less than 40 nanometres.

EX5. An aerosol-generating article according to any one of examples EX1 to EX4, wherein the metal layer has a thickness of greater than or equal 20 nanometres.

EX6. An aerosol-generating article according to any one of examples EX1 to EX5, wherein the metal layer has a thickness of greater than or equal 25 nanometres.

EX7. An aerosol-generating article according to any one of examples EX1 to EX6, wherein the metal layer has a thickness of greater than or equal 30 nanometres.

EX8. An aerosol-generating article according to any one of examples EX1 to EX7, wherein the metal layer has a thickness of between 1 nanometre and 100 nanometres.

EX9. An aerosol-generating article according to any one of examples EX1 to EX8, wherein the metal layer has a thickness of between 10 nanometres and 100 nanometres.

EX10. An aerosol-generating article according to any one of examples EX1 to EX9, wherein the metal layer has a thickness of between 20 nanometres and 80 nanometres.

EX11. An aerosol-generating article according to any one of examples EX1 to EX10, wherein the metal layer has a thickness of between 25 nanometres and 60 nanometres.

EX12. An aerosol-generating article according to any one of examples EX1 to EX11, wherein the metal layer has a thickness of between 30 nanometres and 40 nanometres.

EX13. An aerosol-generating article according to any one of examples EX1 to EX12, wherein the wrapper is wrapped around at least 50 percent of the length of the rod of aerosol-forming substrate.

EX14. An aerosol-generating article according to any one of examples EX1 to EX13, wherein the wrapper is wrapped around at least 90 percent of the length of the rod of aerosol-forming substrate.

EX15. An aerosol-generating article according to any one of examples EX1 to EX14, wherein the wrapper is wrapped around the entire length of the rod of aerosol-forming substrate.

EX16. An aerosol-generating article according to any one of examples EX1 to EX15, wherein the susceptor element extends the entire length of the rod of aerosol-forming substrate.

EX17. An aerosol-generating article according to any one of examples EX1 to EX16, wherein the susceptor element is rod-shaped.

EX18. An aerosol-generating article according to any one of examples EX1 to EX17, wherein susceptor element has a diameter of less than 5 millimetres.

EX19. An aerosol-generating article according to any one of examples EX1 to EX18, wherein susceptor element has a diameter of less than 4 millimetres.

EX20. An aerosol-generating article according to any one of examples EX1 to EX19, wherein susceptor element has a diameter of greater than or equal to 1 millimetres.

EX21. An aerosol-generating article according to any one of examples EX1 to EX20, wherein susceptor element has a diameter of greater than or equal to 2 millimetres.

EX22. An aerosol-generating article according to any one of examples EX1 to EX21, wherein susceptor element has a diameter of between 1 millimetres and 5 millimetres.

EX23. An aerosol-generating article according to any one of examples EX1 to EX22, wherein susceptor element has a diameter of between 2 millimetres and 4 millimetres.

EX24. An aerosol-generating article according to any one of examples EX1 to EX23, wherein the susceptor element is located along a centre line of the rod of aerosol-forming substrate.

EX25. An aerosol-generating article according to any one of examples EX1 to EX24, wherein the aerosol-forming substrate comprises a gel.

EX26. An aerosol-generating article according to any one of examples EX1 to EX24, wherein the aerosol-forming substrate comprises a film.

EX27. An aerosol-generating article according to any one of examples EX1 to EX24, wherein the aerosol-forming substrate comprises crimped tobacco.

EX28. An aerosol-generating article according to any one of examples EX1 to EX24, wherein the aerosol-forming substrate comprises cut tobacco filler.

EX29. An aerosol-generating article according to any one of examples EX1 to EX28, comprising an upstream element located upstream of the rod of aerosol-forming substrate.

EX30. An aerosol-generating article according to example EX29, wherein the upstream element comprises an annular element.

EX31. An aerosol-generating article according to example EX29 or example EX30, wherein the wrapper is wrapped around at least a portion of the upstream element.

EX32. An aerosol-generating article according to example EX31, wherein the wrapper covers the entire length of the upstream element.

EX33. An aerosol-generating article according to any one of examples EX1 to EX32, comprising a downstream element downstream of the rod of aerosol-forming substrate.

EX34. An aerosol-generating article according to example EX33, wherein the downstream element is a hollow tubular segment.

EX35. An aerosol-generating article according to example EX34, wherein the hollow tubular segment is a cellulose acetate tube.

EX36. An aerosol-generating article according to example EX34 or example EX35, wherein the wrapper is wrapped around at least a portion of the hollow tubular segment.

EX37. An aerosol-generating article according to any one of examples EX1 to EX36, wherein the metal layer comprises aluminium.

EX38. An aerosol-generating article according to any one of examples EX1 to EX37, wherein the wrapper comprises a paper layer.

EX39. An aerosol-generating article according to example EX38, wherein the metal layer is radially inward of the paper layer.

EX40. An aerosol-generating article according to example EX38 or example EX39, wherein the wrapper comprises the metal layer deposited on the paper layer.

EX41. An aerosol-generating article according to any one of examples EX38 to EX40, wherein the paper layer has a thickness of greater than or equal to 10 micrometres.

EX42. An aerosol-generating article according to any one of examples EX38 to EX41, wherein the paper layer has a thickness of less than 120 micrometres.

EX43. An aerosol-generating article according to any one of examples EX38 to EX42, wherein the paper layer has a thickness of between 40 micrometres and 80 micrometres.

EX44. An aerosol-generating article according to any one of examples EX1 to EX43, wherein the aerosol-forming substrate has an aerosol former content of greater than or equal 5 percent by weight.

EX45. An aerosol-generating article according to any one of examples EX1 to EX44, wherein the aerosol-forming substrate has an aerosol former content of greater than or equal 20 percent by weight.

EX46. An aerosol-generating article according to any one of examples EX1 to EX45, wherein the aerosol-forming substrate has an aerosol former content of greater than or equal 50 percent by weight.

EX47. An aerosol-generating article according to any one of examples EX1 to EX46, wherein a ratio of the thickness of the susceptor element to the thickness of the metal layer is less than 2500.

EX48. An aerosol-generating article according to any one of examples EX1 to EX47, wherein a ratio of the thickness of the susceptor element to the thickness of the metal layer is greater than or equal to 1500.

EX49. An aerosol-generating article according to any one of examples EX1 to EX48, wherein a ratio of the thickness of the susceptor element to the thickness of the metal layer is between 1500 and 2500.

EX50. An aerosol-generating system comprising:
the aerosol-generating article of any one of examples EX1 to EX49; and
an aerosol-generating device, the aerosol-generating device comprising:
   an atomiser;
   a power supply; and
   a controller, the controller being programmed to control the power supplied from the power supply to the atomiser.

The invention will be further described with reference to the drawings shown in the accompanying Figures, in which:

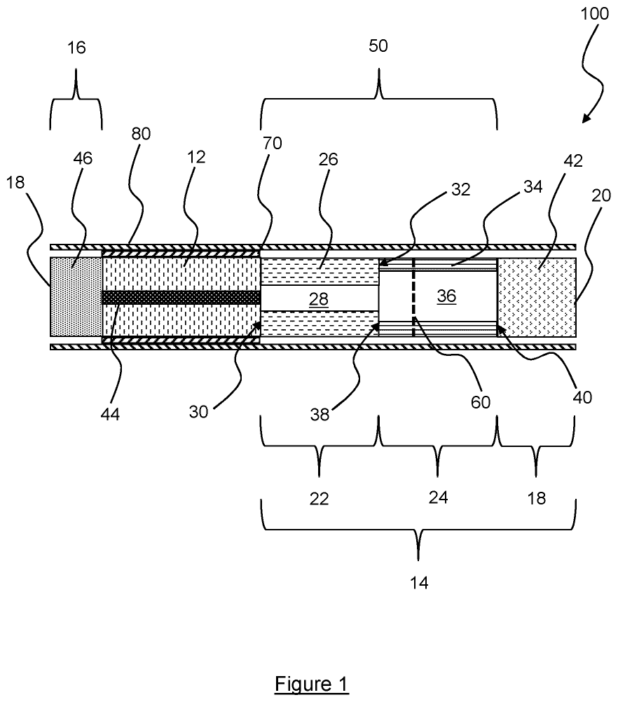

FIG. 1 shows a schematic side sectional view of an aerosol-generating article in accordance with the invention;

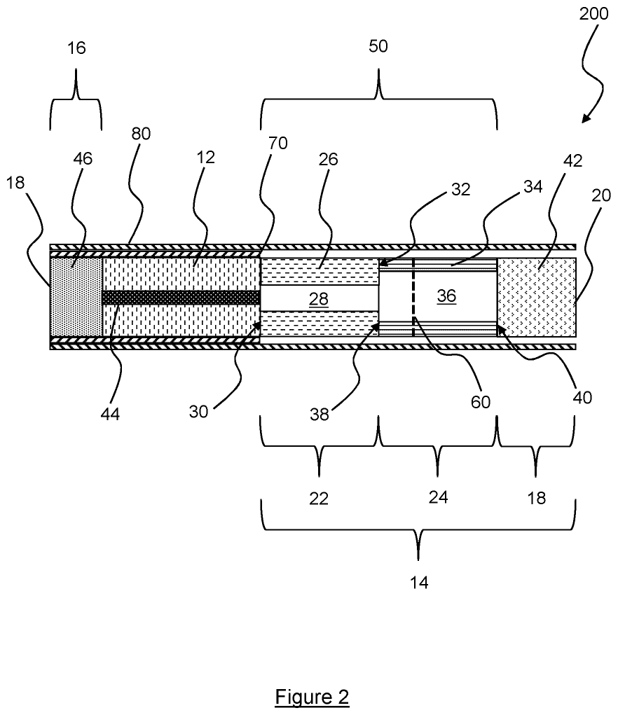

FIG. 2 shows a schematic side sectional view of another aerosol-generating article in accordance with the invention; and

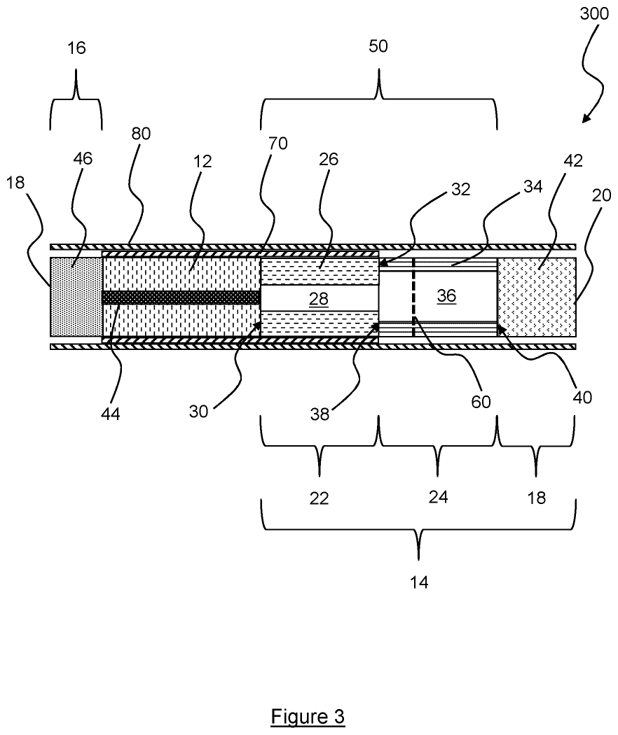

FIG. 3 shows a schematic side sectional view of another aerosol-generating article in accordance with the invention.

Aerosol-generating systems for delivering an aerosol to a user typically comprise an aerosol-generating article and an atomiser. The aerosol-generating article includes a rod of aerosol-forming substrate. The atomiser is configured to generate an inhalable aerosol from the aerosol-forming substrate. Some known aerosol-generating systems comprise a thermal atomiser such as an electric heater or an inductive heating device. The thermal atomiser is configured to heat and vaporise the aerosol-forming substrate to generate an aerosol, which can be inhaled by a user. Typical aerosol-forming substrates for use in aerosol-generating systems are nicotine formulations, which may include an aerosol former such as glycerine.

It has been found that, in some cases, a quantity of one or more components of the aerosol-forming substrate, such as glycerine or nicotine, may leak away from the rod and migrate to other parts of the aerosol-generating article. Migration of the aerosol-forming substrate away from the rod may reduce the amount of aerosol-forming substrate that can be vaporised and then inhaled by a user. Migration of nicotine from the aerosol-forming substrate may reduce the amount of nicotine that can be inhaled by a user

Some partial solutions to migration of nicotine and other components away from the rod of aerosol-forming substrate may involve wrapping the rod of aerosol-forming substrate with metallic foil. However, the present inventors have found that there is a general prejudice in the electronic cigarette industry against using metallic foil with an aerosol-generating article that contains a susceptor element. This is due to the potential of the metallic foil to interfere with heating of the susceptor element.

Another known solution is to wrap the aerosol-generating article in hydrophobic paper. However, the present inventors have found that when using hydrophobic paper, some of the aerosol former in the rod of aerosol-forming substrate may migrate into the paper during the process of manufacturing the aerosol-generating article. This can dampen or soften the hydrophobic paper, which may make the aerosol-generating article difficult to handle, or may result in the aerosol-generating becoming jammed in a machine used for manufacturing the aerosol-generating article.

FIG. 1 shows an example of an aerosol-generating article 10.

The aerosol-generating article 100 includes a rod 12 of aerosol-forming substrate. In one example, the rod 12 is formed by crimping a portion of a sheet of cast leaf tobacco. In other examples, the rod 12 of aerosol-forming substrate may include a different substrate, such as, for example, a gel, a film or cut tobacco filler.

The aerosol-generating article 100 also includes a downstream section 14 and an upstream section 16. The downstream section 14 is at a location downstream of the rod 12 of aerosol-forming substrate. The upstream section 16 is at a location upstream of the rod 12 of aerosol-forming substrate. In this example, the aerosol-generating article 100 extends from an upstream end (or distal end) 18 to a downstream end (or mouth end) 20.

In the example shown in FIG. 1, the aerosol-generating article 100 has an overall length of about 45 millimetres.

The downstream section 14 includes a support element 22 located immediately downstream of the rod 12 of aerosol-forming substrate. The support element 22 is in longitudinal alignment with the rod 12 of aerosol-forming substrate.

In the example shown in FIG. 1, the upstream end of the support element 22 abuts the downstream end of the rod 12 of aerosol-forming substrate.

The downstream section 14 includes an aerosol-cooling element 24. The aerosol-cooling element 24 is located immediately downstream of the support element 22. The aerosol-cooling element 24 is in longitudinal alignment with the rod 12 of aerosol-forming substrate and the support element 22. In the example shown in FIG. 1, an upstream end of the aerosol-cooling element 24 abuts a downstream end of the support element 22.

The support element 22 and the aerosol-cooling element 24 together define an intermediate hollow section 50 of the aerosol-generating article 10.

The support element 22 includes a first hollow tubular segment 26. In the example of FIG. 1, the first hollow tubular segment 26 is provided in the form of a hollow cylindrical tube made of cellulose acetate. The first hollow tubular segment 26 defines an internal cavity 28 that extends all the way from an upstream end 30 of the first hollow tubular segment 26 to a downstream end 32 of the first hollow tubular segment 26. The internal cavity 28 is substantially empty, and so substantially unrestricted airflow is enabled along the internal cavity 28.

In the example shown in FIG. 1, the first hollow tubular segment 26 has a length of about 8 millimetres, an external diameter of about 7.25 millimetres, and an internal diameter of about 1.9 millimetres. Thus, a thickness of a peripheral wall of the first hollow tubular segment 26 is about 2.67 millimetres.

The aerosol-cooling element 24 includes a second hollow tubular segment 34. In the example of FIG. 1, the second hollow tubular segment 34 is provided in the form of a hollow cylindrical tube made of cellulose acetate. The second hollow tubular segment 34 defines an internal cavity 36 that extends all the way from an upstream end 38 of the second hollow tubular segment to a downstream end 40 of the second hollow tubular segment 34. The internal cavity 36 is substantially empty, and so substantially unrestricted airflow is enabled along the internal cavity 36.

In the example shown in FIG. 1, the second hollow tubular segment 34 has a length of about 8 millimetres, an external diameter of about 7.25 millimetres, and an internal diameter of about 3.25 millimetres. Thus, a thickness of a peripheral wall of the second hollow tubular segment 34 is about 2 millimetres. Thus, a ratio between the internal diameter of the first hollow tubular segment 26 and the internal diameter of the second hollow tubular segment 34 is about 0.75.

The aerosol-generating article 100 has a ventilation zone 60 provided at a location along the second hollow tubular segment 34. In the example of FIG. 1, the ventilation zone 60 is provided at about 2 millimetres from the upstream end of the second hollow tubular segment 34. A ventilation level of the aerosol-generating article 100 is about 25 percent.

The downstream section 14 includes a mouthpiece element 42 at a location downstream of the intermediate hollow section 50. The mouthpiece element 42 is positioned immediately downstream of the aerosol-cooling element 24. As shown in the drawing of FIG. 1, an upstream end of the mouthpiece element 42 abuts the downstream end 40 of the aerosol-cooling element 18.

In the example of FIG. 1, the mouthpiece element 42 is provided in the form of a cylindrical plug of low-density cellulose acetate. The mouthpiece element 42 has a length of about 12 millimetres and an external diameter of about 7.25 millimetres.

In the example of FIG. 1, the rod 12 of aerosol-forming substrate has an external diameter of about 7.25 millimetres and a length of about 12 millimetres.

The aerosol-generating article 100 includes an elongate susceptor element 44 within the rod 12 of aerosol-forming substrate. The susceptor element 44 is arranged substantially longitudinally within the aerosol-generating substrate, such as to be approximately parallel to the longitudinal direction of the rod 12 of aerosol-forming substrate. The susceptor element 44 is positioned in a radially central position within the rod 12 and extends effectively along the longitudinal axis of the rod 12.

The susceptor element 44 extends all the way from an upstream end to a downstream end of the rod 12 of aerosol-forming substrate. In effect, the susceptor element 44 has substantially the same length as the rod 12 of aerosol-forming substrate.

In the example of FIG. 1, the susceptor element 44 is provided in the form of a strip and has a length of about 12 millimetres, a thickness of about 60 micrometres, and a width of about 4 millimetres.

The upstream section 16 includes an upstream element 46. The upstream element 46 is located immediately upstream of the rod 12 of aerosol-forming substrate. The upstream element 46 is in longitudinal alignment with the rod 12.

The downstream end of the upstream element 46 abuts the upstream end of the rod 12 of aerosol-forming substrate. Advantageously, this may prevent the susceptor element 44 from being dislodged. Further, this may ensure that the user cannot accidentally contact the heated susceptor element 44 after use.

In the example of FIG. 1, the upstream element 46 is provided in the form of a cylindrical plug of cellulose acetate. The upstream element 46 has a length of about 5 millimetres.

The aerosol-generating article 100 includes a wrapper 70. The wrapper 70 is wrapped around the rod 12 of aerosol-forming substrate. The wrapper 70 includes a metal layer. In the example of FIG. 1, the metal is aluminium. In the example of FIG. 1, the wrapper 70 also includes a paper layer. In one example, the metal layer is deposited on the paper layer. For example, the metal layer may be deposited on the paper layer by use of vapour deposition.

In the example of FIG. 1, the metal layer has a thickness of 40 nanometres, and the paper layer has a thickness of 60 micrometres.

In some examples, the wrapper 70 is wrapped around the entire of the circumferential surface area of the rod 12 of aerosol-forming substrate.

The wrapper 70 is provided to act as a physical barrier between the rod 12 of aerosol-forming substrate and other components of the aerosol-generating article 10.

The aerosol-generating article 100 includes an outermost wrapper 80. In the example of FIG. 1, the outermost wrapper 80 is wrapped around all of the components of the aerosol-generating article 10. The outermost wrapper 80 is also wrapper around the wrapper 70.

FIGS. 2 and 3 show alternative examples to the example shown in Figures. The aerosol-generating article 200 of FIG. 2 and the aerosol-generating article 300 of FIG. 3 are the same as the aerosol-generating article 100 of FIG. 1 except for the following differences.

In the example shown in FIG. 2, the wrapper 70 is wrapped around both the rod 12 of aerosol-forming substrate and the upstream element 46. In contrast, in the example shown in FIG. 1, the wrapper 70 is only wrapped around the rod 12 of aerosol-forming substrate. In the example of FIG. 2, the wrapper 70 is wrapped around the entire length of the upstream element 46. However, in some examples, the wrapper 70 may only be wrapped around part of the length of the upstream element 46.

In the example shown in FIG. 3, the wrapper 70 is wrapped around both the rod 12 of aerosol-forming substrate and the first hollow tubular segment 26. In contrast, in the example shown in FIG. 1, the wrapper 70 is only wrapped around the rod 12 of aerosol-forming substrate.

In the example of FIG. 2, the wrapper 70 is wrapped around the entire length of the first hollow tubular segment 26. However, in some examples, the wrapper 70 may only be wrapped around part of the length of the first hollow tubular segment 26.

An example formulation of a suitable aerosol-forming substrate for the examples of FIGS. 1, 2 and 3 is shown in Table 1.

| Example | A |
|---|---|
| Glycerine (% by weight) | 74.4 |
| Water (% by weight) | 20 |
| Nicotine (% by weight) | 1.5 |
| Sodium Carboxymethyl Cellulose (% by weight) | 2.4 |
| Lactic Acid (% by weight) | 1.7 |

The provision of a wrapper 70 that is wrapped around the rod 12 of aerosol-forming substrate, and includes a metal layer, may help to contain one or more of the components of the aerosol-forming substrate within the rod 12. In other words, the wrapper 70 may help to reduce migration of one or more components of an aerosol-forming substrate away from the rod 12 and into other parts of the aerosol-generating article 100. In some examples, this may result in an increase in the nicotine yield from the plug 12 of aerosol-forming substrate.

The increase in nicotine yield is because the metal layer of the wrapper may prevent or at least reduce the migration of components of the aerosol-forming substrate, such as the aerosol-former, out of the rod 12 and into other parts of the aerosol-generating article 100. It follows that if more of the aerosol-forming substrate is retained within in the rod 12 then it is possible to yield more nicotine from the aerosol-forming substrate.

In addition, while the metal layer helps to mitigate migration of components away from the rod 12 of aerosol-forming substrate, the metal layer is thin enough so that the metal layer may not interfere with induction heating of the susceptor element 44. This means that induction heating of the susceptor element 44 may not be impacted by the metal layer of the wrapper 70.

Moreover, some aerosol-generating devices include a controller that monitors how much energy is provided to the susceptor element 44. Wrappers that have thick metal layers may interact with the feedback provided to the controller, which could result in inefficient heating of the susceptor element 44. The thinness of the metal layer of the wrapper 70 may reduce interference between the metal layer and the controller, which may result in more consistent heating of the susceptor element 44.

The specific examples described above illustrate but do not limit the invention. It is to be understood that other examples of the invention may be made and the specific examples described herein are not exhaustive.

1-15. (canceled)

16. An aerosol-generating article, comprising:
a rod of aerosol-forming substrate, the rod comprising a susceptor element within the aerosol-forming substrate; and
a wrapper wrapped around the rod of aerosol-forming substrate,
wherein the wrapper comprises a metal layer, and
wherein the metal layer has a thickness of less than 100 nanometres.

17. The aerosol-generating article according to claim 16, wherein the metal layer has a thickness of between 25 nanometres and 60 nanometres.

18. The aerosol-generating article according to claim 16, wherein the wrapper is wrapped around at least 50 percent of a length of the rod of aerosol-forming substrate.

19. The aerosol-generating article according to claim 16, wherein the susceptor element has a diameter of between 2 millimetres and 4 millimetres.

20. The aerosol-generating article according to claim 16, further comprising an upstream element located upstream of the rod of aerosol-forming substrate.

21. The aerosol-generating article according to claim 20, wherein the wrapper is wrapped around at least a portion of the upstream element.

22. The aerosol-generating article according to claim 16, wherein the metal layer comprises aluminium.

23. The aerosol-generating article according to claim 16, wherein the wrapper further comprises a paper layer.

24. The aerosol-generating article according to claim 23, wherein the wrapper further comprises the metal layer deposited on the paper layer.

25. The aerosol-generating article according to claim 23, wherein the paper layer has a thickness of between 40 micrometres and 80 micrometres.

26. The aerosol-generating article according to claim 16, wherein the aerosol-forming substrate has an aerosol former content of greater than or equal 5 percent by weight.

27. The aerosol-generating article according to claim 16, wherein a ratio of a thickness of the susceptor element to a thickness of the metal layer is less than 2500.

28. The aerosol-generating article according to claim 16, wherein a ratio of a thickness of the susceptor element to a thickness of the metal layer is greater than or equal to 1500.

29. The aerosol-generating article according to claim 16, wherein a ratio of a thickness of the susceptor element to a thickness of the metal layer is between 1500 and 2500.

30. An aerosol-generating system, comprising:
the aerosol-generating article according to claim 16; and
an aerosol-generating device, the aerosol-generating device comprising:
an atomiser,
a power supply, and
a controller, the controller being programmed to control the power supplied from the power supply to the atomiser.
